(19) United States
(12) Patent Application Publication
(10) Pub. No.: US 2003/0015072 A1
(43) Pub. Date: Jan. 23, 2003

(54) Variable pivot locking pliers

(76) Inventor: Wayne W. Chou, Ridgefield, CT (US)

Correspondence Address: George R. Pettit, Connolly Bove Lodge & Hutz LLP, P.O. Box 19088, Washington, DC, 20036-0088, US

(21) Appl. No.: 09/909,880

(22) Filed: Jul. 23, 2001

(51) Int. Cl. B25B 7/04

(52) U.S. Cl. 81/402

(57) ABSTRACT

Gripping pliers having upper and lower jaws facing each other. An upper handle supports a bearing member extending through first and second walls of the upper handle. A supporting member connected to the lower jaw extends through the upper handle, and is supported to the upper handle via a bearing member which is free to rotate. A threaded ring within the bearing member adjusts the length of the supporting member, thereby establishing a distance between the gripping jaws of the pliers. A relatively constant facing relationship between upper and lower jaws is maintained through the geometry created by the location of the bearing axis relative to the distance between the pivot point of the lower jaw and a pivot formed by the end of the toggle link.

### FIELD OF THE INVENTION

The present invention relates to the field of handtools. Specifically, a type of locking pliers are shown which maintain a substantially constant facing relationship between the jaws of the pliers for various distances between the jaws.

### BACKGROUND OF THE INVENTION

The prior art is replete with examples of handtools for gripping objects of different sizes. These include gas or universal pliers, channel lock pliers, as well as wrenches, which can be adjusted to accommodate a given size of an object.

The gripping pliers of the prior art have jaws which are connected to a common pivot point, forming an angle between the jaws which is made large enough to grasp an object. One type of pliers called locking pliers have the ability to grasp and maintain a lock on a given object. Typically, however, these locking pliers grasp the object at an angle which is determined by the object's size. As the angle increases with object size, the amount of force applied perpendicular to the grasped object decreases as the angle between the jaws increases. The result is a reduction in the ability to maintain a secure grasp.

Other handtools, such as channel lock pliers, utilize a grooved series of joints which permits different grasping ranges to be set while minimizing the angular displacement of the jaws with respect to each other. While the pliers generally provide for parallel gripping surfaces, they lack the feature of being able to lock the jaws to the object. The present invention is directed to providing a locking type pliers with gripping surfaces having a facing relationship which may be maintained substantially constant to improve the hold over objects of different sizes.

### SUMMARY OF THE INVENTION

In accordance with the invention, a gripping pliers which can be locked to an object is provided. The gripping pliers include an upper and lower jaw having facing gripping surfaces. The upper jaw is connected to an upper handle which extends rearward of the jaws. The lower jaw has a support member extending through the upper handle, and supported to the upper handle with a rotable bearing. Means are provided in the upper handle to adjust the position of the support member, to position the lower jaw with respect to the upper jaw, and the bearing member permits rotation of the support member so that the jaws can remain in an essentially a constant facing relationship and avoid any change in angular position with respect to each other. A lower handle is pivotally connected to the lower jaw. A toggle member is pivotally connected to the lower handle and extends into the upper handle, where it bears against a bearing surface. The lower handle, upper handle, and toggle member permit a force to be applied between the jaws when the two handles are closed against each other.

In accordance with a preferred embodiment, the gripping pliers have jaws with an essentially parallel relationship. A bias spring is connected between a lower jaw and upper handle for biasing the jaws apart when they are not grasping an object. Further, a release lever may be pivotally connected to the lower handle to force the toggle member about its pivot point thereby releasing the grip of the jaws on the object.

### BRIEF DESCRIPTION OF THE DRAWINGS

FIG. 1 is a plan view of a locking pliers in accordance with an embodiment of the invention;

FIG. 2 illustrates in greater detail the support of the lower jaw in a bearing within the upper handle;

FIG. 3 is a top view illustrating the connection between the lower jaw and upper handle; and

FIG. 4 is a section view, taken along line 4-4, of FIG. 2 illustrating the bearing supporting the lower jaw support within the upper handle.

### DETAILED DESCRIPTION OF THE PREFERRED EMBODIMENT

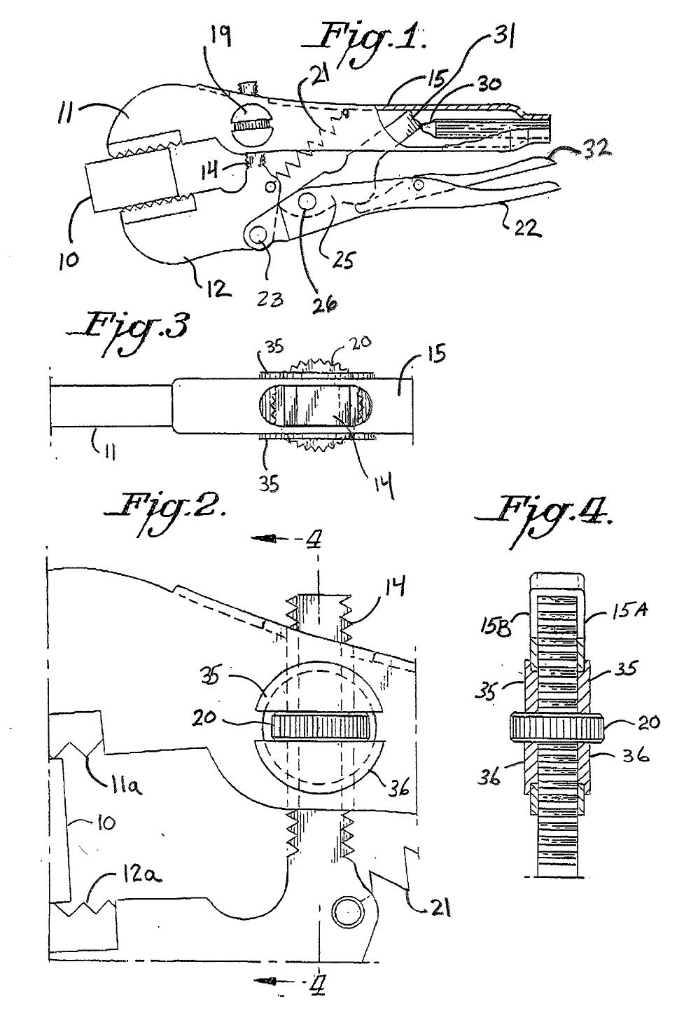

Referring now to FIG. 1, a plan view of a gripping pliers in accordance with a preferred embodiment is shown. An object 10 is grasped between an upper jaw 11 and lower jaw 12 under the force exerted by the lower handle 22, toggle link 25, against the upper handle 15 and jaw 11. Jaw 11 is formed integral with the upper handle 15. Handle 15 has sidewalls 15A, 15B, shown particularly in FIG. 4, forming a channel. The channel includes fixed at one end thereof a bearing surface 30 which bears against a camming surface at one end 31 of the toggle 25. A rotating bearing 19 is supported within the walls of the upper handle 15.

The lower jaw 12 is supported via a supporting member 14 to the upper handle 15. The support is effected through a rotatable bearing 19 within the walls of the upper handle 15. As is illustrated in FIGS. 2 and 4, the bearing 19 includes a pair of flanges 35 and 36 on both sides of the handle 15.

The bearings are formed as half bearing segments inserted through the walls 15A and 15B of the upper handle. The flanges on each side of the half bearings captivate the side walls of the handle 15.

The bearings are separated by a space for receiving a rotary member 20 having internal threads. The threaded support member 14 has a generally rectangular cross section and has threads on the two narrower sides which complement the internal thread of rotary member 20. The support member 14 is captivated between the walls of the upper handle. Rotation of rotary member 20 will position the support member 14 and move the connected lower jaw 12 towards and away from the upper jaw 11 positioning the jaws.

A gripping force is applied to the lower jaw 12 via the toggle link 25 pivotally connected to a lower handle 22 which is, in turn, pivotally connected at 23 to the lower jaw 12. The remaining end 31 of toggle link 25 includes a camming surface which bears against a bearing surface 30.

A nominal distance is established between the jaws 11 and 12, which is slightly smaller than the object 10 being grasped. Once the nominal distance has been set by rotating rotable member 20, the force is applied between handles 22 and 15 so that they achieve a locked condition by virtue of the relationship between pivots 26 and 23. The shape of the support member 14 being generally rectangular helps prevent the lower jaw from rotating in yaw since it is confined from rotation by the walls of handle 15 A breaking handle 32 may be provided which is pivotally connected to handle 22. When the lock is to be broken, the handle 22 is forced away from toggle 25 about pivot 26 so that the force exerted by toggle 25 on handle 22 and lower jaw 12 is removed.

The foregoing embodiment permits the adjustment of the space between jaws 11 and 12, while maintaining the jaws in a substantially parallel relationship. By parallel relationship, this also includes the case where the gripping surfaces 11a and 12a on the jaws 11, 12 are disposed around a generally curved surface. In this instance, the curved surfaces remain in substantially the same relationship to each other as the distance between jaws 11 and 12 is adjusted. As conventional gripping pliers, the surfaces 11a, 12a may be serrated or contain scoring marks to facilitate grasping.

The facing relationship between jaws 11 and 12 is accomplished by having the bearing 19 rotate as the distance between the jaws 11 and 12 is set by rotary member 20. As the member 14 supported in bearing 19 can swivel within the handle 15, the basic angular relationship, which is parallel in accordance with the preferred embodiments, between surfaces 11a and 12a can be maintained. This relationship is geometrically established by the distance between the axis of bearing 19 and the rotational axis defined by camming surface 31 and bearing surface 30 relative to the radius of travel formed by pivot 23 and that rotational axis defined by camming surface 31 and bearing surface 30.

A spring 21 may be connected between the lower jaw 12 and the upper handle 15 to bias the jaws 11 and 12 open, as is conventional in locking type pliers.

The camming surface 31 and bearing 30 cooperate to reduce the arc in which pivot 23 moves as the handles 22 and 15 are moved together. In this way, any displacement of surfaces 11a and 12a into a non-parallel relationship is further reduced by reducing the arc in which pivot 23 travels.

Thus, there has been disclosed with respect to the one embodiment its illustration and description. Additionally, the disclosure shows and describes only the preferred embodiments of the invention, but is to be understood that the invention of capable of use in various other combinations, modifications, and environments and is capable of changes or modifications within the scope of the inventive concept as expressed herein, commensurate with the above teachings and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

What is claimed is:

1. Gripping pliers comprising:
an upper jaw having a gripping surface connected to an upper handle;
a lower jaw having a gripping surface facing said upper jaw gripping surface; said lower jaw having at one end a support pivotally supported to said upper handle;
means connected to said upper handle for adjusting the position of said support in said upper handle whereby said lower jaw can be spaced from said upper jaw while maintaining said upper and lower jaws facing each other;
a lower handle pivotally connected to said lower jaw for rotating said lower jaw into and out of a gripping position with respect to said upper jaw in order to grasp an object between said jaws; and
a toggle link having one end pivotally connected to said lower handle, and having a second end extending into said upper handle for locking said jaws against an object between said jaws when said handles are moved together.

2. The gripping pliers according to claim 1, wherein said second end of said toggle link has a camming surface which abuts a fixed bearing surface, whereby, at various adjusted openings of the pliers, a pivot point of said lower handle moves to adjust the length of the toggle link maintaining said jaws in a constant facing relationship.

3. The gripping pliers according to claim 1, wherein said means for adjusting the position of said support comprises:
a rotary member having internal threads for engaging threads on said support, said rotary member being supported for rotation about an axis perpendicular to said upper handle to permit said lower jaw to pivot as the gripping distance between said jaws changes.

4. The gripping pliers according to claim 3, wherein said rotary member is supported in first and second bearing halves inserted in a hole in said upper handle, said bearing halves having flanges for engaging first and second walls of said upper handle, said bearing halves being spaced apart at distance for receiving said rotary member; whereby said bearing supports, rotary member, and support can pivot in said hole.

5. Gripping pliers comprising:
an upper jaw having a gripping surface;
an upper handle having first and second parallel walls connected to said upper jaw;
a lower jaw having gripping surface facing said upper jaw gripping surface, said lower jaw having a member extending between said first and second walls of said upper handle and through a top surface of said upper handle;
bearing member extending through said first and second walls, supporting a threaded ring engaging like threads on said member for adjusting the length of said member;
a lower handle pivotally connected to said lower jaw; and
a toggle member pivotally connected to said lower handle, having one end extending between said walls, said one end including a camming surface which engages a fixed bearing surface, said toggle link pivoting along said fixed bearing surface as said lower handle is grasped and moves said lower jaw against an object being gripped by said jaws.

6. The gripping pliers according to claim 5 further comprising a bias spring for biasing said jaws apart.

7. The gripping pliers according to claim 6 further comprising a release lever pivotally connected to said lower handle, having one end abutting said toggle for pivoting said toggle about its pivot point thereby releasing the grip of said jaws on said object.

8. The gripping pliers according to claim 5 wherein said lower jaw member has a substantially rectangular cross section.
